(19) United States
(12) Patent Application Publication
(10) Pub. No.: US 2015/0350034 A1
(43) Pub. Date: Dec. 3, 2015

(54) INFORMATION PROCESSING DEVICE, INFLUENCE DETERMINATION METHOD AND MEDIUM

(71) Applicant: NEC CORPORATION, Minato-ku, Tokyo (JP)

(72) Inventor: Shinjiro YAGI, Tokyo (JP)

(21) Appl. No.: 14/759,988

(22) PCT Filed: Jan. 15, 2014
(86) PCT No.: PCT/JP2014/000145

§ 371 Date: Jul. 9, 2015

(30) Foreign Application Priority Data
Jan. 23, 2013 (JP) 2013-010178

(51) Int. Cl. H04L 12/24

(52) U.S. Cl. CPC H04L 41/5016; H04L 41/0876

(57) ABSTRACT

An information processing according to the present invention device includes: a physical configuration selecting unit which selects a physical device to be determined an influence; a logical configuration range specifying unit which specifies a range of a logical configuration related to the physical device; a service level influence specifying unit which determines an achievement state of a service level on the basis of a service level maintained by a service in the logical configuration and a service level value related to the physical device, and specifies a score which is information indicating the degree of an influence given to the service level of the logic configuration on the basis of the achievement state; and a logic information sorting unit which sorts order of displayed information about the logical configurations on the basis of the score.

### TECHNICAL FIELD

The present invention relates to determination of an influence of a failure in an IT (Information Technology) system and, more particularly, to determination of a service level which is subject to an influence of a failure.

### BACKGROUND ART

An IT system is increasing day by day. Consequently, when a failure occurs in an IT system, an influence of the failure becomes larger. Therefore, it is important to determine an influence of a failure in an IT system.

An IT system includes a server for management to determine a failure (refer to, for example, PTL 1 and PTL 2).

A server management device described in PTL 1 includes an information input unit, an editing unit, and a display unit.

The server management device described in PTL 1 operates as follows.

For example, in response to switching of a standby server, a control unit of the server management device gives an instruction to the editing unit. The editing unit displays a logical server icon, a business label, and information of a comment, which are associated with information of a corresponding physical server, on the display unit.

A service configuration management device described in PTL 2 includes a system configuration information storing unit, system configuration information display means, a display information storing unit, edition result registration display means, and an interface unit.

The service configuration management device described in PTL 2 operates as follows.

In the system configuration information storing unit of the service configuration management device of PTL 2, system configuration information indicating the connection relation of devices constructing the system and relationship between services and the devices is registered. The system configuration information display means displays the connection relation between devices used for providing service on the screen of an input/output device, on the basis of the system configuration information.

### CITATION LIST

### Patent Literature

[PLT 1] Japanese Laid-open Patent Application Publication No. 2009-276835

[PLT 2] Japanese Laid-open Patent Application Publication No. 2010-205126

### SUMMARY OF INVENTION

### Technical Problem

The management devices described in PTLs 1 and 2 can determine the location of a failure on a system configuration.

However, the management devices described in PTLs 1 and 2 do not include a quantitative index in determination of an influence of a failure.

For this reason, the management devices described in PTLs 1 and 2 have a problem that the influence on service cannot be determined.

An object of the present invention is to provide an information processing device and an influence determination method capable of solving the problem, determining an influence that a failure in an IT system gives to service, and displaying the service according to the degree of the influence.

### Solution to Problem

An information processing according to an aspect of the present invention device includes: physical configuration selecting means for selecting a physical device to be determined an influence; logical configuration range specifying means for specifying a range of a logical configuration related to the physical device; service level influence specifying means for determining an achievement state of a service level on the basis of a service level maintained by a service in the logical configuration and a service level value related to the physical device, and specifying a score which is information indicating the degree of an influence given to the service level of the logic configuration on the basis of the achievement state; and logic information sorting means for sorting order of displayed information about the logical configurations on the basis of the score.

An influence determining method according to an aspect of the present invention includes: selecting a physical device to be determined an influence; specifying a range of a logical configuration related to the physical device; determining an achievement state of a service level on the basis of a service level maintained by a service in the logical configuration and a service level value related to the physical device, and specifying a score which is information indicating the degree of an influence given to the service level of the logical configuration on the basis of the achievement state; and sorting order of displayed information about the logical configuration on the basis of the score.

A computer-readable recording medium according to an aspect of the present invention recording a program which makes a computer execute: processing of selecting a physical device to be determined an influence; processing of specifying a range of a logical configuration related to the physical device; processing of determining an achievement state of a service level on the basis of a service level maintained by a service in the logical configuration and a service level value related to the physical device, and specifying a score which is information indicating the degree of an influence given to the service level of the logical configuration on the basis of the achievement state; and processing of sorting order of displayed information about the logical configuration on the basis of the score.

### Advantageous Effects of Invention

According to the present invention, a failure in a device can be displayed according to the degree of an influence on service.

### BRIEF DESCRIPTION OF DRAWINGS

FIG. 1 is a block diagram illustrating an example of the configuration of an information processing device according to a first exemplary embodiment of the present invention.

FIG. 2 is a flowchart illustrating an example of an operation of the information processing device.

FIG. 3 is a diagram illustrating an example of information that a physical configuration managing unit manages.

FIG. 4 is a diagram illustrating an example of information that a logical configuration managing unit manages.

FIG. 5 is a diagram illustrating an example of information that a service level defining unit manages.

FIG. 6 is a diagram illustrating an example of service levels that a service level accumulating unit accumulates.

FIG. 7 is a flowchart illustrating an example of an operation of a service level influence specifying unit.

FIG. 8 is a diagram illustrating an example of scores corresponding to the service levels.

FIG. 9 is a diagram illustrating an example of display contents that an information display unit displays.

FIG. 10 is a diagram illustrating an example of display contents that a logic information sorting unit displays.

FIG. 11 is a block diagram illustrating an example of the configuration of an information processing system according to the first exemplary embodiment.

FIG. 12 is a block diagram illustrating an example of the configuration of an information processing device as a modified example of the first exemplary embodiment.

FIG. 13 is a block diagram illustrating an example of the configuration of an information processing device as a modified example of the first exemplary embodiment.

### DESCRIPTION OF EMBODIMENTS

Next, exemplary embodiments of the present invention will be described with reference to the drawings.

The drawings are each for explaining exemplary embodiments of the present invention. Therefore, the present invention is not limited to the depiction of each drawing. The same numerals are given to similar configurations of each drawing and, in some cases, repetitive description will be omitted.

### First Exemplary Embodiment

First, the configuration of an information processing device 5 according to a first exemplary embodiment of the present invention will be described.

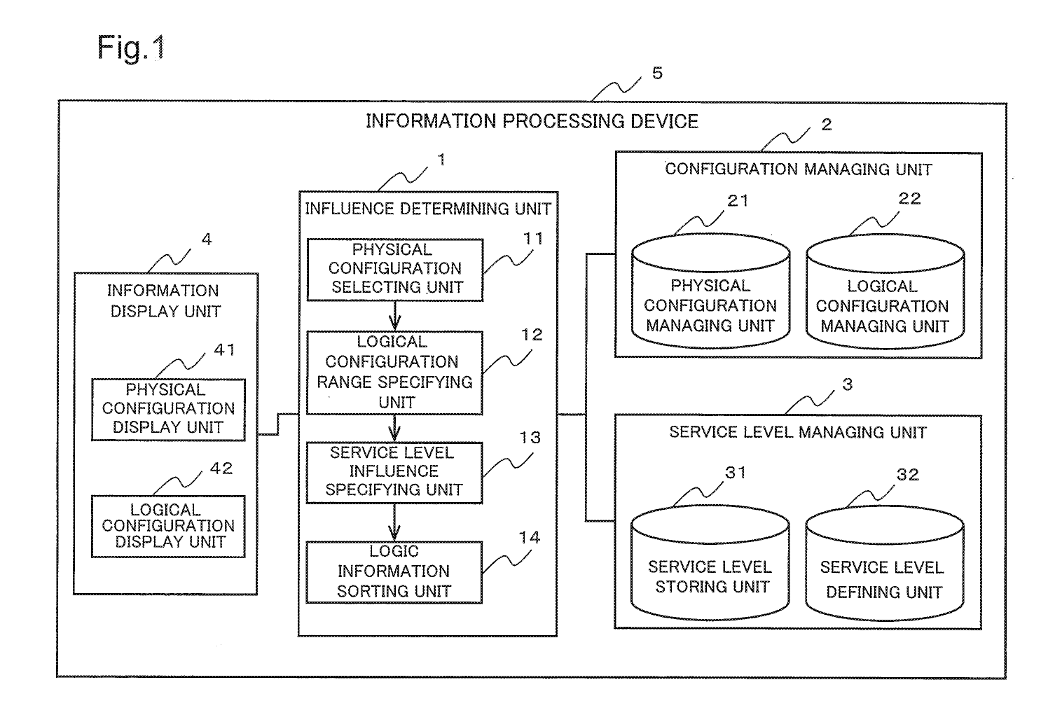

FIG. 1 is a block diagram illustrating an example of the configuration of the information processing device 5 of the first exemplary embodiment.

Referring to FIG. 1, the information processing device 5 of the first exemplary embodiment includes an influence determining unit 1, a configuration managing unit 2, a service level managing unit 3, and an information display unit 4.

Subsequently, the configuration of each unit will be described.

The influence determining unit 1 determines an influence on a service level related to the physical configuration on the basis of information to be managed by the configuration managing unit 2 and the service level managing unit 3. Further, the influence determining unit 1 changes the order of information displayed on the information display unit 4 on the basis of the determination.

For this purpose, the influence determining unit 1 includes a physical configuration selecting unit 11, a logical configuration range specifying unit 12, a service level influence specifying unit 13, and a logic information sorting unit 14.

The physical configuration selecting unit 11 selects a physical device subjecting to determination of an influence. A selecting method of a physical device in the physical configuration selecting unit 11 is not especially limited. For example, the physical configuration selecting unit 11 may select a physical device which is subject to an influence of the failure, on the basis of a result of detecting a failure. The physical configuration selecting unit 11 may receive an instruction from a terminal operated by a not-illustrated user, and select a physical device subjecting to determination of an influence.

The logical configuration range specifying unit 12 specifies a range (for example, logic information, service, and a user) of the physical device that the physical configuration selecting unit 11 selects and a logical configuration related to the physical device.

In the description of the present exemplary embodiment, each configuration in a logical configuration or a physical configuration and a configuration including a logical or physical connection relation related to each configuration are collectively referred to as a “range of configurations”.

The service level influence specifying unit 13 specifies information indicating the degree or order that the service level of the logical configuration cannot be achieved (hereinafter, collectively referred to as a “score”), on the basis of a state of achievement of the service level related to the range that the logical configuration range specifying unit 12 specifies. In other words, the service level influence specifying unit 13 specifies a score, which is information indicating the degree of an influence given to the service level.

The logic information sorting unit 14 changes (sorts) the order of display information in the display of the logical configuration related to the physical device, on the basis of the result (score) that the service level influence specifying unit 13 specifies.

The configuration managing unit 2 manages information of physical devices (for example, a server device, a network device, and a server device of a virtual machine) to be managed, including a device to be determined by influence determining unit 1, and logical resources.

For this purpose, the configuration managing unit 2 includes a physical configuration managing unit 21 and a logical configuration managing unit 22.

The physical configuration managing unit 21 manages physical devices to be managed (for example, a server device, a network device, and a server device of a virtual machine (hereinafter, simply called “virtual machine” in some cases)). Physical devices to be managed by the physical configuration managing unit 21 include a physical device, an influence on which is determined.

The logical configuration managing unit 22 manages logical resources (for example, user information, the service, and the virtual machine) related to the physical devices to be managed.

The service level managing unit 3 manages a service level. For this purpose, the service level managing unit 3 includes a service level storing unit 31 and a service level defining unit 32.

The service level storing unit 31 stores a value of the service level calculated based on a value summed from the physical devices operating (for example, the virtual machine, the server device, and the network device). The service level defining unit 32 manages service level information (for example, a target value) that the service of the logical configuration maintains.

The information display unit 4 displays various information of the information processing device 5. For this purpose, the information display unit 4 includes a physical configuration display unit 41 and a logical configuration display unit 42.

The physical configuration display unit 41 displays a physical configuration. Describing in more detail, the physical configuration display unit 41 displays information of the physical configuration managing unit 21 and physical devices (for example, a server device, a network device, and a virtual machine) related to the physical device that the physical configuration selecting unit 11 selects.

The logical configuration display unit 42 displays a logical configuration. Describing in more detail, the logical configuration display unit 42 displays information of the logical configuration managing unit 22, the logical configuration related to the physical information that the physical configuration selecting unit 11 selects, and a service level.

The display position and format of information in the information display unit 4 are not especially limited.

Next, referring to FIGS. 1 to 10, the operation of the information processing device 5 of the present exemplary embodiment will be described in detail.

First, a precondition used for description of the operation will be described.

Each information item to be used in the following description is information for describing the present exemplary embodiment. Therefore, the present exemplary embodiment is not limited to information described in each drawing.

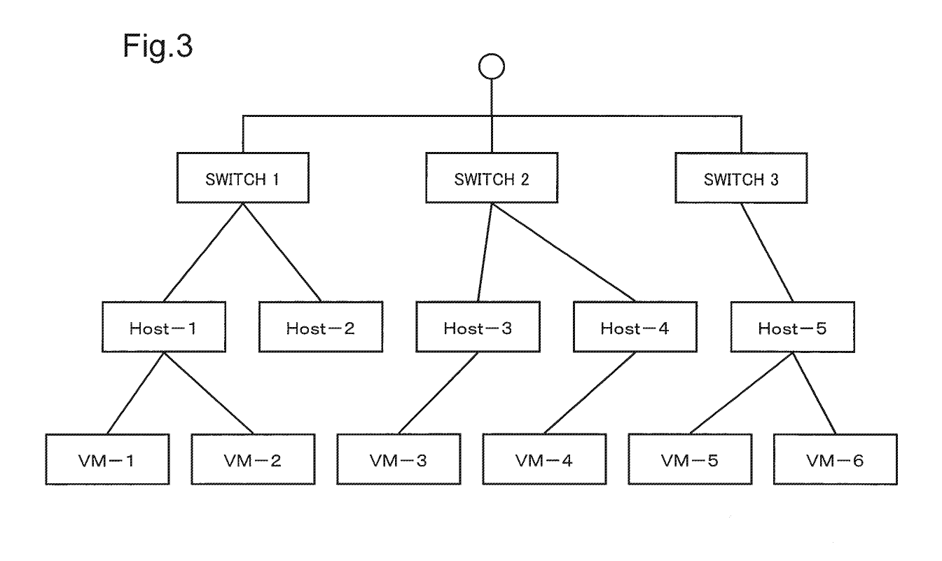

FIG. 3 is a diagram illustrating an example of information that is managed by the physical configuration managing unit 21 according to the present description. As illustrated in FIG. 3, the physical configuration managing unit 21 manages information of a network device (“Switch” in FIG. 3), a server device (“Host” in FIG. 3), and a virtual machine (“VM” in FIG. 3), and a mutual connection state.

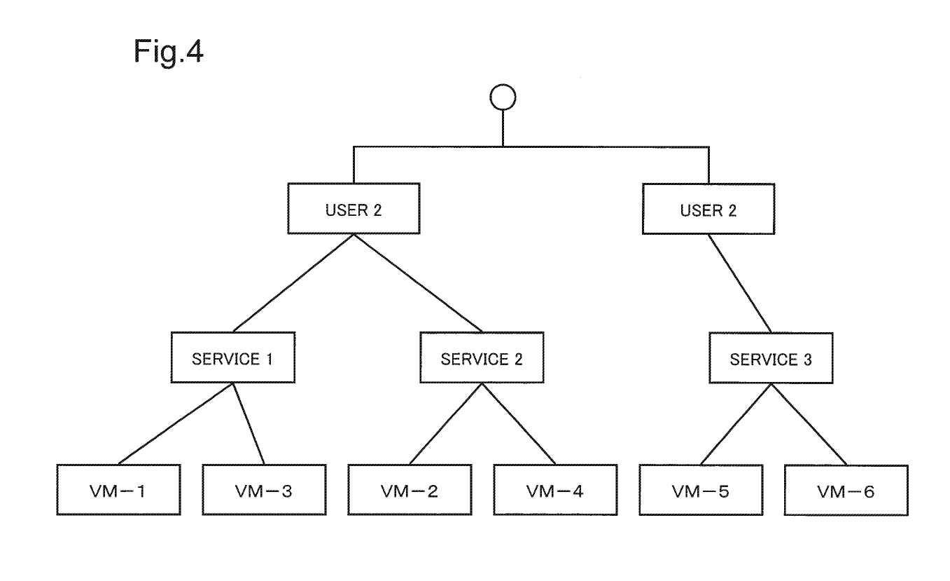

FIG. 4 is a diagram illustrating an example of information that is managed by the physical configuration managing unit 22 according to the present description. As illustrated in FIG. 4, the logical configuration managing unit 22 manages user information (“Users” in FIG. 4), a plurality of services managed by the users (“Services” in FIG. 4), device information which configures the services (“VM” in FIG. 4), and mutual connection information.

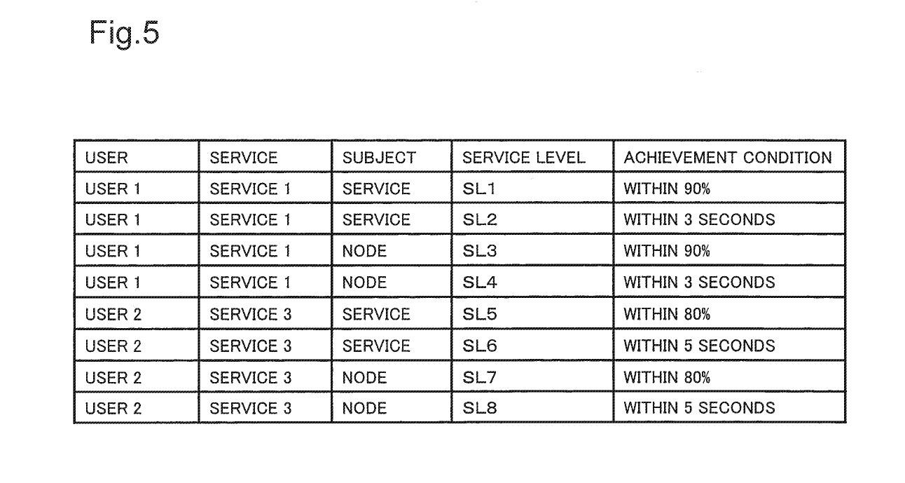

FIG. 5 is a diagram illustrating an example of service level information that the service level defining unit 32 manages. As illustrated in FIG. 5, the service level information managed by the service level defining unit 32 includes users, services, subjects for services, service levels of subjects, and achievement conditions of service levels. The users and the services correspond to the users and the services illustrated in FIG. 4.

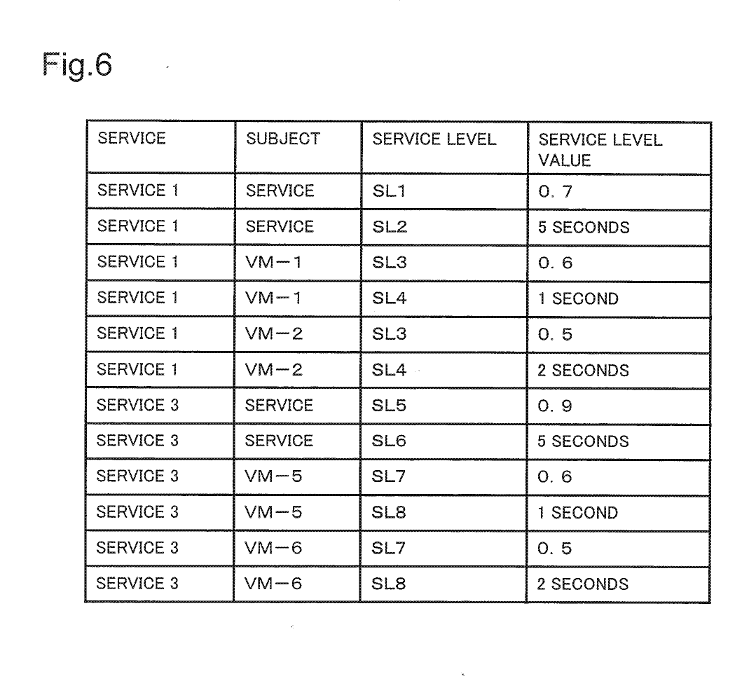

FIG. 6 is a diagram illustrating an example of service levels that the service level storing unit 31 stores. As illustrated in FIG. 6, information stored in the service level storing unit 31 includes services, subjects for services, service levels, and service level values indicating the levels of the services.

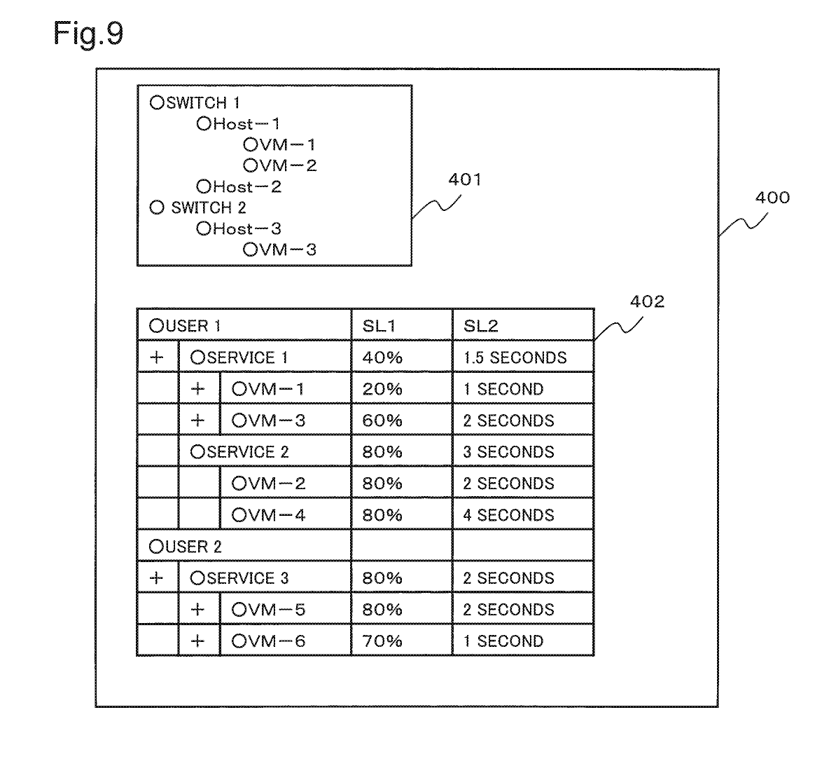

FIG. 9 is a diagram illustrating an example of display contents that the information display unit 4 displays. A screen 400, which is displayed by the information display unit 4 and illustrated in FIG. 9, includes a display part 401 of physical configurations that the physical configuration managing unit 21 manages and a display part 402 of logical configurations that the logical configuration managing unit 22 manages. In other words, the physical configuration display unit 41 displays information of physical configurations on the display part 401 in FIG. 9. The logical configuration display unit 42 displays information of logical configurations on the display part 402 in FIG. 9.

The range of information that the information display unit 4 displays is not especially limited. The information display unit 4 may display all of the information. Alternatively, the information display unit 4 may display, for example, a part of information to assure easiness to see the display.

In the description of the present exemplary embodiment, the physical configuration display unit 41 displays a part of the information of the physical configuration managing unit 21 (refer to FIG. 3) on the display part 401 in FIG. 9, to clarify the display. In FIG. 9, the logical configuration display unit 42 displays all of the information of the logical configuration managing unit 22 (refer to FIG. 4) on the display part 402.

Next, the operation of the information processing device 5 of the present exemplary embodiment will be described.

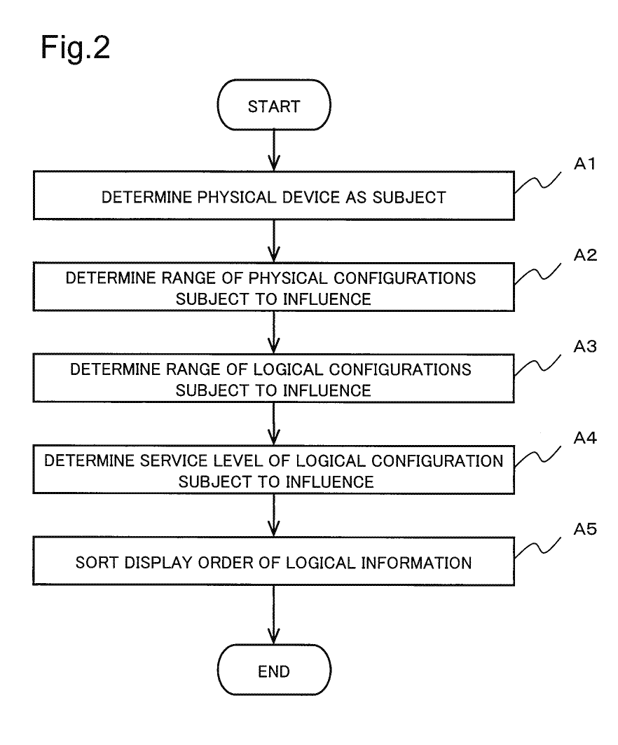

FIG. 2 is a flowchart illustrating an example of the operation of the information processing device 5.

First, the physical configuration selecting unit 11 determines a physical device subjecting to determination of an influence (step A1).

As already described, the physical configuration selecting unit 11 selects a physical device on the basis of, for example, monitoring information of operation management (detection of a failure) or explicit specification of a user (an instruction from a user terminal).

Next, the logical configuration range specifying unit 12 determines the range of physical configurations related to (influenced by) the physical device that the physical configuration selecting unit 11 selects (step A2).

More specifically, the logical configuration range specifying unit 12 selects a physical device which matches the physical device that the physical configuration selecting unit 11 selects from the information managed by the physical configuration managing unit 21. The logical configuration range specifying unit 12 selects a physical device by using comparison processing, for example, on the basis of a unique name such as the host name of the physical device, IP (Internet Protocol) address, MAC (Media Access Control) address, or an identifier by which a device can be unconditionally identified.

In this case, the physical device selected by the logical configuration range specifying unit 12 and a physical device having a link of a lower order of the selected physical device are physical devices which are subject to an influence. For example, when the logical configuration range specifying unit 12 selects “Host-1” in FIG. 3, “Host-1”, and “VM-1” and “VM-2” lower than Host-1 are physical devices which are subject to an influence.

Next, the logical configuration range specifying unit 12 determines a logical configuration related to the physical devices positioned at the lower order selected (step A3).

The logical configuration range specifying unit 12 determines a corresponding logical configuration from the information that the logical configuration managing unit 22 manages, by using information of the physical devices at the lower order determined in step A2. The logical configuration range specifying unit 12 determines a corresponding logical configuration by comparing, for example, the unique name, the IP address, the MAC address, or the identifier by which a device can be unconditionally identified with similar information in the logical configuration of information that the logical configuration managing unit 22 manages. The unique name is, for example, the host name of a device of information that the physical configuration managing unit 21 mentioned above manages.

The logical configuration that the logical configuration range specifying unit 12 selects and a logical configuration higher than the selected logical configuration (for example, service and user) are a range subject to an influence. For example, in FIG. 4, when “VM-1” and “VM-2” are logic devices in a low order, “service 1” and “service 2” positioned at a higher order than the logic devices, and “user 1” at higher order than the services are a logical configuration range which is subject to an influence.

Next, the service level influence specifying unit 13 specifies an influence range of a service level, on the basis of the logical configuration range that the logical configuration range specifying unit 12 determines. The service level influence specifying unit 13 determines a service level of a logical configuration which is subject to an influence (step A4).

Detailed operation of the service level influence specifying unit 13 will be described with reference to the drawings.

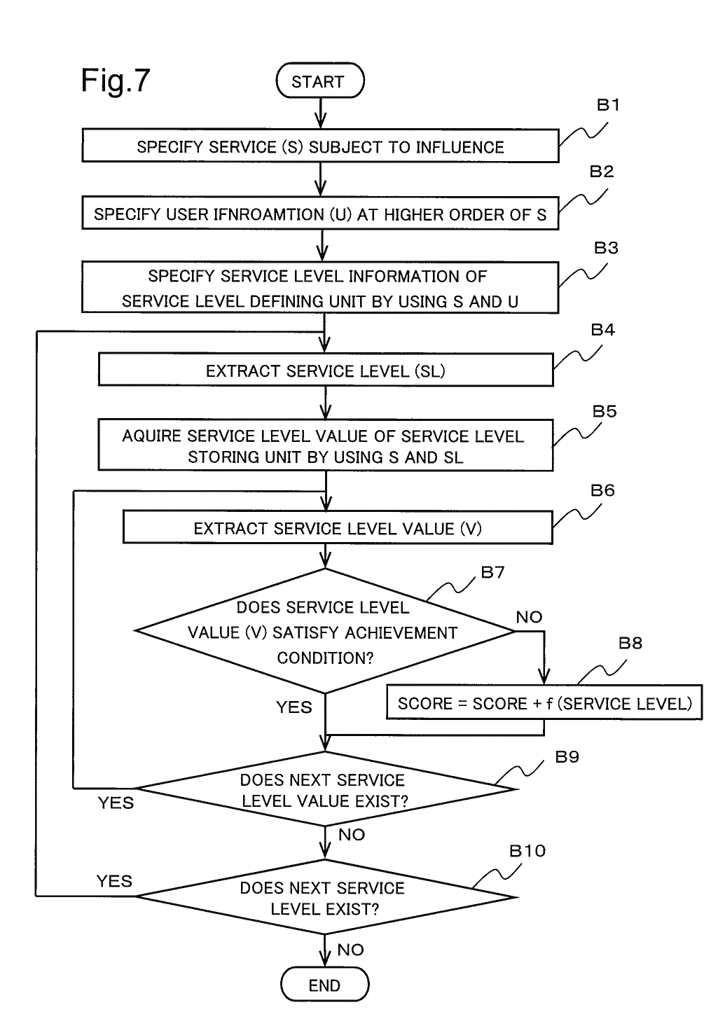

FIG. 7 is a flowchart illustrating an example of an operation of the service level influence specifying unit 13 of the present exemplary embodiment.

The service level influence specifying unit 13 specifies a service which is subject to an influence (for example, “service 1” and “service 2” in FIG. 4) (step B1). Hereinafter, a specified service will be referred to as “S”.

The service level influence specifying unit 13 specifies user information (“user 1” in FIG. 4) in the order higher than the specified service (step B2). Hereinafter, specified user information will be referred to as “U”.

Using (as keys) the specified service (S) and the user information (U), the service level influence specifying unit 13 specifies information relating to a service level related to the service from service level information (FIG. 5) that the service level defining unit 32 manages (step B2). The information related to the service level is, for example, a service level, a subject and an achievement condition.

When a plurality of pieces of specified service level information exist, the service level influence specifying unit 13 extracts any one piece of service level information (step B4). A method in which the service level influence specifying unit 13 selects (extracts) service level information is not especially limited. The service level influence specifying unit 13 may extract service level information in order or at random. Hereinafter, the service level of the extracted service level information will be set as “SL”. The service level influence specifying unit 13 initializes the score of the extracted service level (for example, sets the score to “1”).

Using (as keys) the service level (SL) and the service (S), the service level influence specifying unit 13 acquires a service level value from the service level storing unit 31 (step B5).

When there are a plurality of acquired service level values, the service level influence specifying unit 13 extracts any one of service level value (step B6). The selecting method is also not especially limited. Hereinafter, the extracted service level value will be set as “V”.

The service level influence specifying unit 13 compares the service level value (V) with an achievement condition of the service level information (step B7). In other words, the service level influence specifying unit 13 determines whether the service level value satisfies the achievement condition or not.

When the service level value does not satisfy the achievement condition (it is service level violation) (NO in step B7), the service level influence specifying unit 13 adds a value calculated by using a service level calculating method to the value of the score (step B8). Hereinafter, the service level calculating method will be referred to as “f(service level)”.

In f(service level), it is assumed that a constant is preliminarily defined for each kind of a service level. The f(service level) is not limited to the above and may be set, for example, for each of the service level and types of a service (for example, time and achievement rate).

A method used as the service level calculating method (f(service level)) is not especially limited. For example, f(service level) may be a value acquired by deducting achievement degree of the service level from 1. Alternatively, as f(service level), a predetermined evaluation function may be used.

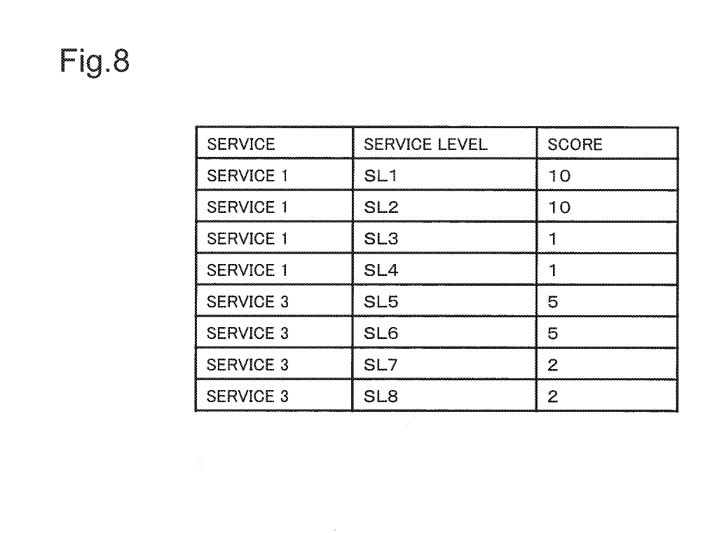

FIG. 8 is a diagram illustrating an example of scores corresponding to service levels.

For example, the score of service level SL1 of service 1 in FIG. 8 is “10”. As described above, the score is added when the service level value does not satisfy the achievement condition. Therefore, the score of a service level which does not satisfy the achievement condition grows bigger. In other words, the service level SL1 whose score is “10” has a lot of achievement conditions which are not satisfied more than the service level SL3 whose score is “1”. In such a manner, the score is information indicating the degree of an influence on the service level.

When the service level value satisfies the achievement condition (YES in step B7) and after the score is added, the service level influence specifying unit 13 determines whether there is a service level value which is not determined or not (step B9).

When a service level value which is not determined exists (YES in step B9), the service level influence specifying unit 13 repeats the processing from step B6 on the next service level value.

When all of service level values are determined (NO in step B9), the service level influence specifying unit 13 determines whether service level information (service level) which is not determined remains or not (step B10).

When a service level which is not determined exists (YES in step B10), the service level influence specifying unit 13 repeats the processing from step B4 on the next service level.

When all of service levels are determined (NO in step B10), the service level influence specifying unit 13 finishes the processing.

In other words, the service level influence specifying unit 13 repeats the processing illustrated in FIG. 7 on all of services which are subject to influences.

Referring again to FIG. 2, the description will be continued.

After the operation of the service level influence specifying unit 13, the logic information sorting unit 14 sorts the services in descending order of values of scores calculated by the service level influence specifying unit 13, and displays the result on the logical configuration display unit 42 (step A5). In accordance with a change on display of the logical configuration display unit 42, the logic information sorting unit 14 displays a physical device specified by the logical configuration range specifying unit 12 on the physical configuration display unit 41. In other words, the logic information sorting unit 14 changes display of the information display unit 4, on the basis of the scores.

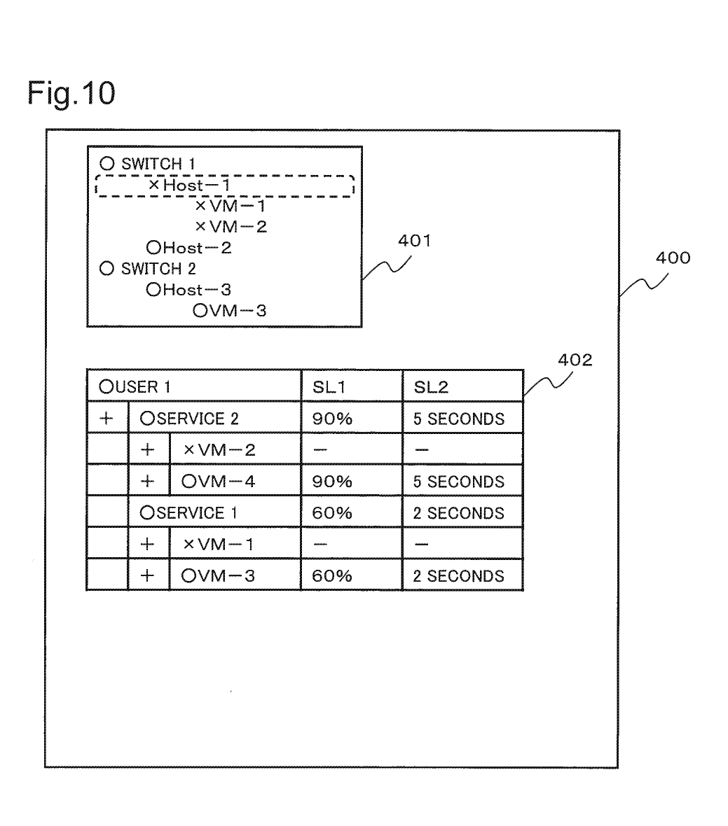

FIG. 10 is a diagram illustrating an example of display contents that the logic information sorting unit 14 displays after processing. FIG. 10 is an example of display when the physical configuration selecting unit 11 selects “Host-1” as a physical device in which many service level violations occur. On the display part 401 in FIG. 10, “Host-1” is indicated by broken line.

At the lower order of “Host-1”, “VM-1” and “VM-2” exist. It is assumed that the number of violations in “VM-2” is larger than that in “VM-1”. “VM-2” relates to the logical configuration “service 2”. Consequently, the score of the service 2 related to “VM-2”, where the largest number of violations occur, is the highest.

“VM-1” relates to the logical configuration “service 1”. It is assumed that the number of violations in “VM-1” is the second largest after “VM-2”. Consequently, the score of the service 1 related to “VM-1” is the second highest after “service 2”. In other words, the scores of services (services 2 and 1), in which many service level violations occur, are higher than those of other services. Therefore, on the display part 402 in FIG. 10, “service 2” and “service 1” (and related “user 1”) are displayed on an upper side on which they are more visible than the other services.

As described above, the information processing device 5 of the present exemplary embodiment can display a service in which many violations occur on the upper side. A violation is an example of a failure in an IT system. In other words, the information processing device 5 displays a service influenced by a failure in an IT system on the upper side of the logical configuration display unit 42 of the information display unit 4. A worker who checks the information display unit 4 checks the display on the upper side of the display part 402, and can easily determine an influenced service.

However, the information processing device 5 does not have to limit display based on a score to display on the upper side of the display part 402. The information processing device 5 may employ another display method on the basis of magnitudes of scores. For example, the information processing device 5 may change the size of a character or thickness of a character on the basis of scores.

In FIG. 10, to clarify the description, display of services below “user 1” is not illustrated.

Next, effects of the present exemplary embodiment will be described.

The information processing device 5 of the present exemplary embodiment can determine the degree of an influence on a service of a physical device. Further, the information processing device 5 can display services which are subject to influences, in order based on score which is information indicating the degree of influences of the service levels.

As described above, the information processing device 5 of the present exemplary embodiment can display services according to the degree of influences on services by a failure in an IT system. In other words, the information processing device 5 of the present exemplary embodiment can achieve an effect of displaying services so that the degree of an influence on a service can be easily determined.

The reason is as follows.

The physical configuration selecting unit 11 of the information processing device 5 of the present exemplary embodiment selects a physical device to be determined an influence. The logical configuration range specifying unit 12 specifies a logical configuration range related to the physical device. The service level influence specifying unit 13 calculates a score on the basis of an achievement state of the service level related to the logical configuration range.

As described above, the information processing device 5 of the present exemplary embodiment can specify, as a score, the degree of an influence on a physical device.

Further, the logic information sorting unit 14 of the present exemplary embodiment sorts information of logical configurations displayed on the basis of the scores. Consequently, the information processing device 5 of the present exemplary embodiment can display a logical configuration (for example, a service) in order based on an achievement state of a service level.

### Modified Example

The configuration of the information processing device 5 is not limited to the above description. The information processing device 5 may divide each of configurations to a plurality of configurations.

For example, in the information processing device 5, the logic information sorting unit 14 may be divided to a function of sorting logical configurations and a function of changing displays of corresponding physical configurations. In the information processing device 5, the physical configuration managing unit 21 and the logical configuration managing unit 22 in the configuration managing unit 2 may be realized by using other storing devices.

In the information processing device 5, at least a part of the influence determining unit 1, the configuration managing unit 2, the service level managing unit 3, and the information display unit 4 may be different devices which are connected via a network or a bus.

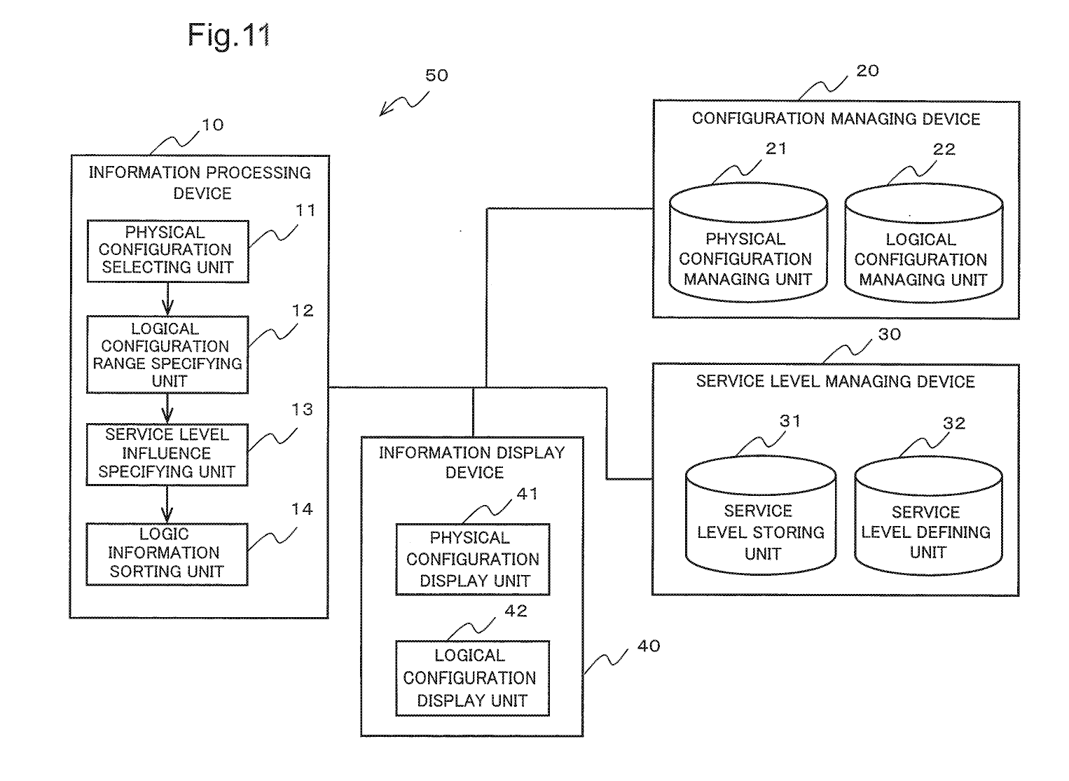

FIG. 11 is a block diagram illustrating an example of the configuration of an information processing system 50 according to the present exemplary embodiment. In FIG. 11, the same reference numerals are given to the same configurations as those in FIG. 1 and detailed description will be omitted.

The information processing system 50 includes an information processing device 10 corresponding to the influence determining unit 1, a configuration managing device 20 corresponding to the configuration managing unit 2, a service level managing device 30 corresponding to the service level managing unit 3, and an information display device 40 corresponding to the information display unit 4. The devices are each connected via a network and realize functions of each unit of the information processing device 5.

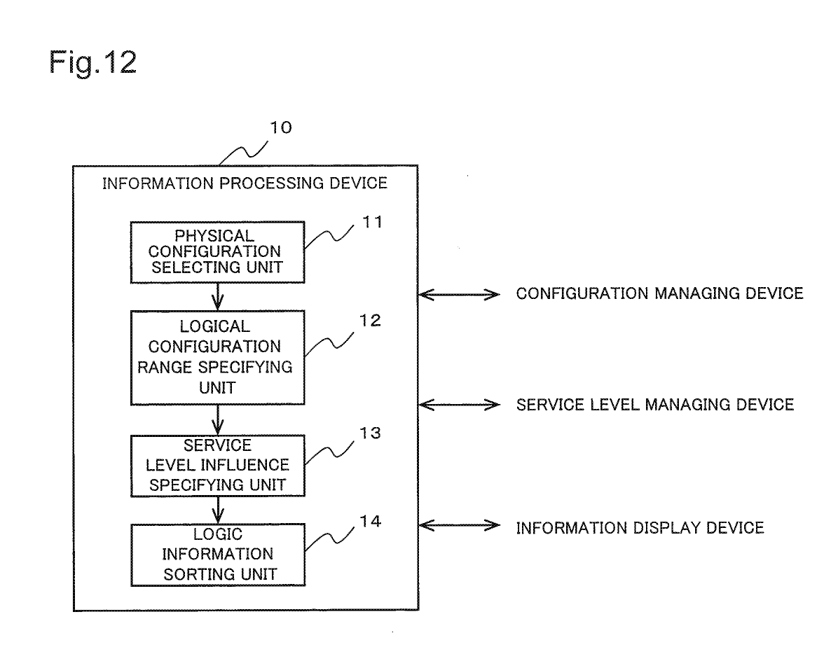

FIG. 12 is a block diagram illustrating an example of the configuration of the information processing device 10.

The information processing device 10 illustrated in FIG. 12 includes the physical configuration selecting unit 11, the logical configuration range specifying unit 12, the service level influence specifying unit 13, and the logic information sorting unit 14.

The physical configuration selecting unit 11 in the information processing device 10 can select a physical device to be determined an influence, like the physical configuration selecting unit 11 in the information processing device 5.

The logical configuration range specifying unit 12 can specify a logical configuration range related to the physical device that the physical configuration selecting unit 11 selects, by using the configuration managing device 20.

The service level influence specifying unit 13 can specify a score on the basis of an achievement state of a service level related to the logical configuration range, by using the service level managing device 30.

As described above, in a manner similar to the information processing device 5, the information processing device 10 can achieve an effect capable of specifying, as a score, the degree of an influence on a physical device.

Further, the logic information sorting unit 14 in the information processing device 10 sorts information of logical configurations displayed in the information display device 40, on the basis of scores that the service level influence specifying unit 13 specifies. In other words, the information processing device 10 can sort logical configurations (for example, services) in order based on the achievement state of the service level, like the information processing device 5.

As described above, the information processing device 10 can realize functions similar to those of the information processing device 5.

The information processing device 10 is the minimum configuration of the present exemplary embodiment.

In the information processing devices 5 and 10, a plurality of configurations may be set as one configuration.

For example, each of the information processing devices 5 and 10 may be realized as a computer device including a CPU (Central Processing Unit), a ROM (Read Only Memory), and a RAM (Random Access Memory). Further, the information processing device 5 may also be realized as a computer device including, in addition to the above-described configurations, an Input/Output Circuit (IOC) and a Network Interface Circuit (NIC).

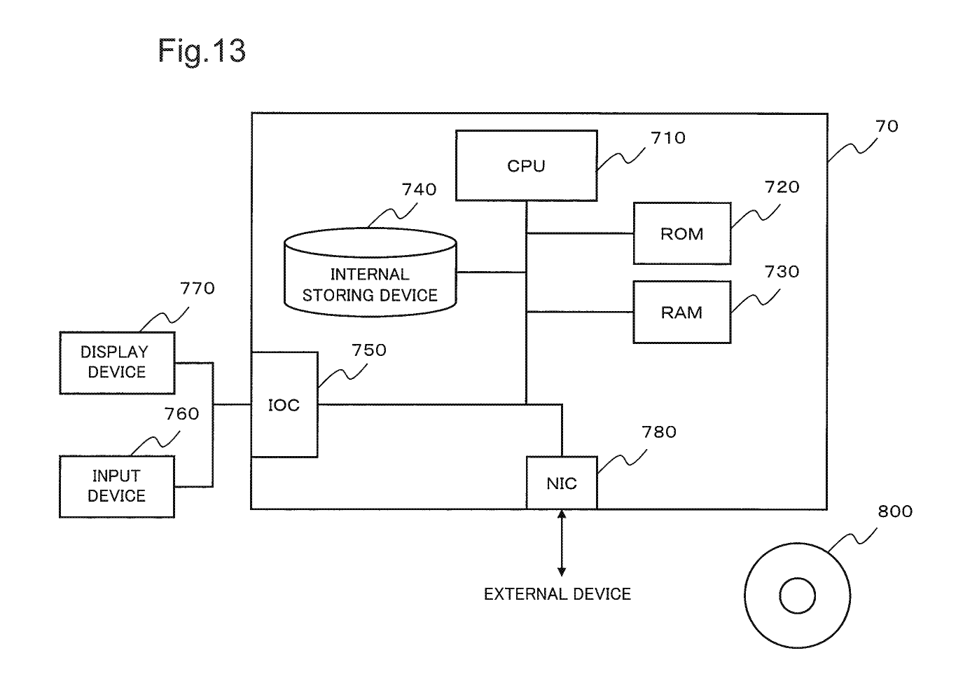

FIG. 13 is a block diagram illustrating an example of the configuration of an information processing device 70 as a modified example of the information processing device 5 of the present exemplary embodiment.

The information processing device 70 includes a CPU 710, a ROM 720, a RAM 730, an internal storing device 740, an IOC 750, and an NIC 780, and constructs a computer.

The CPU 710 reads a program from the ROM 720. On the basis of the read program, the CPU 710 controls the RAM 730, the internal storing device 740, the IOC 750, and the NIC 780. The CPU 710 controls those configurations and realizes functions as the influence determining unit 1, the configuration managing unit 2, the service level managing unit 3, and the information display unit 4 illustrated in FIG. 1. At the time of realizing each function, the CPU 710 may use the RAM 730 as temporarily storing of the program.

The CPU 710 may read a program included in a storage medium 800 which computer-readably stores a program by using a not-illustrated storage medium reading device. Alternatively, the CPU 710 may receive a program from a not-illustrated external device via the NIC 780.

The ROM 720 stores a program to be executed by the CPU 710 and fixed data. The ROM 720 is, for example, a P-ROM (Programmable-ROM) or a flash ROM.

The RAM 730 temporarily stores a program to be executed by the CPU 710 and data. The RAM 730 is, for example, a D-RAM (Dynamic-RAM).

The internal storing device 740 stores data and a program to be stored for long time by the information processing device 70. The internal storing device 740 may operate as a temporary storing device of the CPU 710. Further, the internal storing device 740 may operate as the configuration managing unit 2 or the service level managing unit 3. The internal storing device 740 is, for example, a hard disk device, a magneto-optic disk device, an SSD (Solid State Drive), or a disk array device.

The IOC 750 mediates data between the CPU 710, and an input device 760 and a display device 770. The IOC 750 is, for example, an IO interface card.

The input device 760 is a device for receiving an input instruction from the operator of the information processing device 70. The input device 760 is, for example, a keyboard, a mouse, or a touch panel.

The display device 770 is a device displaying information to the operator of the information processing device 70. The display device 770 is, for example, a liquid crystal display. The display device 770 may operate as the information display unit 4.

The NIC 780 relays exchange of data with an external device via a network. The NIC 780 is, for example, a LAN (Local Area Network) card. The information processing device 70 may use a not-illustrated external device connected via the NIC 780 as the information display unit 4.

The information processing device 70 configured as described above can achieve an effect similar to that of the information processing device 5.

The reason is that the CPU 710 of the information processing device 70 can realize functions similar to those of the information processing device 5 on the basis of a program.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2013-010178, filed on Jan. 23, 2013, the disclosure of which is incorporated herein in its entirety by reference.

The whole or part of the exemplary embodiments disclosed above can be described as, but not limited to, the following supplementary notes.

(Supplementary Note 1)

An information processing device includes:

physical configuration selecting means for selecting a physical device to be determined an influence;

logical configuration range specifying means for specifying a range of a logical configuration related to the physical device;

service level influence specifying means for determining an achievement state of a service level on the basis of a service level maintained by a service in the logical configuration and a service level value related to the physical device, and specifying a score which is information indicating the degree of an influence given to the service level of the logic configuration on the basis of the achievement state; and

logic information sorting means for sorting order of displayed information about the logical configurations on the basis of the score.

(Supplementary Note 2)

The information processing device according to supplementary note 1, further includes:

configuration managing means includes:

physical configuration managing means for managing information of physical devices to be management targets including the physical device selected by the physical configuration selecting means; and

logical configuration managing means for managing information of logical resources including a range of the logic configurations specified by the logical configuration range specifying means.

(Supplementary Note 3)

The information processing device according to supplementary note 1 or supplementary note 2, further includes:

service level managing means includes:

service level defining means for managing service level information maintained by services of the logical configurations referred to by the service level influence specifying means; and

service level storing means for storing a service level value related to a physical device referred to by the service level influence specifying means.

(Supplementary Note 4)

The information processing device according to any one of supplementary notes 1 to 3, further includes:

information display means includes:

physical configuration display means for displaying the physical configuration; and

logical configuration display means for displaying the logical configuration.

(Supplementary Note 5)

An influence determining method includes:

selecting a physical device to be determined an influence;

specifying a range of a logical configuration related to the physical device;

determining an achievement state of a service level on the basis of a service level maintained by a service in the logical configuration and a service level value related to the physical device, and specifying a score which is information indicating the degree of an influence given to the service level of the logical configuration on the basis of the achievement state; and

sorting order of displayed information about the logical configuration on the basis of the score.

(Supplementary Note 6)

A computer-readable recording medium recording a program which makes a computer execute:

processing of selecting a physical device to be determined an influence;

processing of specifying a range of a logical configuration related to the physical device;

processing of determining an achievement state of a service level on the basis of a service level maintained by a service in the logical configuration and a service level value related to the physical device, and specifying a score which is information indicating the degree of an influence given to the service level of the logical configuration on the basis of the achievement state; and

processing of sorting order of displayed information about the logical configuration on the basis of the score.

### INDUSTRIAL APPLICABILITY

The present invention can be applied to a system which specifies services and users to which an influence is extended and handles the problem on the basis of the degree of service level violation when a problem such as a failure occurs in a device.

The present invention is also applicable to a monitoring device which checks users and service levels of services to which an influence is extended when a device selected on a GUI (Graphical User Interface) is specified.

### REFERENCE SIGNS LIST

1 Influence determining unit
2 Configuration managing unit
3 Service level managing unit
4 Information display unit
5 Information processing device
10 Information processing device
11 Physical configuration selecting unit
12 Logical configuration range specifying unit
13 Service level influence specifying unit
14 Logic information sorting unit
20 Configuration managing device
21 Physical configuration managing unit
22 Logical configuration managing unit
30 Service level managing device
31 Service level storing unit
32 Service level defining unit
40 Information display device
41 Physical configuration display unit
42 Logical configuration display unit
50 Information processing system
70 Information processing device
400 Screen
401 Display part
402 Display part
710 CPU
720 ROM
730 RAM
740 Internal storing device
750 IOC
760 Input device
770 Display device
780 NIC
800 Storing medium

What is claimed is:

1. An information processing device comprising:
a physical configuration selecting unit which selects a physical device to be determined an influence;
a logical configuration range specifying unit which specifies a range of a logical configuration related to the physical device;
a service level influence specifying unit which determines an achievement state of a service level on the basis of a service level maintained by a service in the logical configuration and a service level value related to the physical device, and specifies a score which is information indicating the degree of an influence given to the service level of the logic configuration on the basis of the achievement state; and
a logic information sorting unit which sorts order of displayed information about the logical configurations on the basis of the score.

2. The information processing device according to claim 1, further comprising:
a configuration managing unit comprising:
a physical configuration managing unit which manages information of physical devices to be management targets including the physical device selected by the physical configuration selecting unit; and
a logical configuration managing unit which manages information of logical resources including a range of the logic configurations specified by the logical configuration range specifying unit.

3. The information processing device according to claim 1, further comprising:
a service level managing unit comprising:
a service level defining unit which manages service level information maintained by services of the logical configurations referred to by the service level influence specifying unit; and
a service level storing unit which stores a service level value related to a physical device referred to by the service level influence specifying unit.

4. The information processing device according to claim 1, further comprising:
an information display unit comprising:
a physical configuration display unit which displays the physical configuration; and
a logical configuration display unit which displays the logical configuration.

5. An influence determining method comprising:
selecting a physical device to be determined an influence;
specifying a range of a logical configuration related to the physical device;
determining an achievement state of a service level on the basis of a service level maintained by a service in the logical configuration and a service level value related to the physical device, and specifying a score which is information indicating the degree of an influence given to the service level of the logical configuration on the basis of the achievement state; and
sorting order of displayed information about the logical configuration on the basis of the score.

6. A computer-readable non-transitory recording medium embodying a program, the program causing an information processing device to perform a method, the method comprising:
selecting a physical device to be determined an influence;
specifying a range of a logical configuration related to the physical device;
determining an achievement state of a service level on the basis of a service level maintained by a service in the logical configuration and a service level value related to the physical device, and specifying a score which is information indicating the degree of an influence given to the service level of the logical configuration on the basis of the achievement state; and
sorting order of displayed information about the logical configuration on the basis of the score.
